(19) United States
(12) Patent Application Publication
(10) Pub. No.: US 2008/0040977 A1
(43) Pub. Date: Feb. 21, 2008

(54) SECURITY WINDOW OR DOOR WITH BURGLAR-RETARDANT FEATURES

(75) Inventor: Heinrich Salzer, Marburg (DE)

Correspondence Address: Ursula B. Day;Henry M. Feiereisen, LLC, Suite 4714, 350 Fifth Avenue, New York, NY, 10118, US

(73) Assignee: Salzer Sicherheitstechnik GmbH, Marburg (DE)

(21) Appl. No.: 11/830,440

(22) Filed: Jul. 30, 2007

(30) Foreign Application Priority Data
Aug. 15, 2006 (EP) EP 06016975

(51) Int. Cl. E05B 65/08

(52) U.S. Cl. 49/50

(57) ABSTRACT

A security window or door has a first locking element fixedly coupled to a pushrod of a casement guided in a mortise area between the casement and a frame which is engaged in formfitting manner in a tilted position of the pushrod with a second locking element fixedly connected in the frame such that both locking elements are pivotable in relation to one another around a tilt axis and disengaged in a rotating position of the pushrod with the second element connected to the frame in fixed manner so that a rotational movement of the casement around the rotational axis is possible and wherein the first locking element is provided with either a pin engaged in a matching bearing hole of the second locking element or at least one bearing hole with which the pin of the second locking element may be engaged with a tilted or a closed position of the pushrod.

### CROSS-REFERENCES TO RELATED APPLICATIONS

This application claims the priority of European Patent Application Serial No. 06 016 975, filed Aug. 15, 2006, pursuant to 35 U.S.C. 119(a)-(d), the subject matter of which is incorporated herein by reference.

### BACKGROUND OF THE INVENTION

The present invention relates to a security window or a security door in a burglar-retardant embodiment, having a frame anchorable in an opening of a building and a casement provided with a filling and mounted in the frame so it is tiltable around a horizontal tilt axis and rotatable around a vertical rotational axis, whose tilt movement is delimited in a tilt final position by at least one security scissor hinge which connects the casement to the frame and is preferably attached on the side of the casement diametrically opposite the tilt axis, and having a first locking element coupled fixed to a pushrod of the casement guided concealed in a mortise area between the casement and the frame, which is engaged in a formfitting way in a tilt position of the pushrod with a second locking element connected fixed in the frame in such a way that both locking elements are pivotable around the tilt axis in relation to one another, and, in a rotating position, the pushrod is disengaged from the second locking element connected fixed to the frame, so that a rotational movement of the casement around the rotational axis is possible.

Up to this point, the relevant standards of burglar-retardance in windows or doors have always related to the closed state of the casement, which is mounted in the frame so it is rotatable and/or tiltable. In the closed state, locking elements situated on the casement, which are typically displaced using a pushrod which is in turn actuated using a one-hand rotating handle, into matching designed locking elements, which are situated fixed on the frame. Comparatively good security to attempts at breaking in or breaking open is achieved by an appropriately large number of locking elements, i.e., a configuration thereof at short distances to one another on all four casement legs (typically two vertical and two horizontal) as much as possible, in connection with a strongly pronounced form fit between the locking elements, which, according to EP 1 516 996 A2, for example, are implemented in form of male and female molds and engage with one another in a formfitting way.

A window is disclosed in DE 94 09 388 U1, whose frame and casement are connected in the tilt axis of the window in the tilt position via a “mushroom head” connection, so that a relative movement in this area between frame and casement is prevented.

Furthermore, windows having tilt-turn function are known from DE 885 211 C and DE 659 001 C, whose adjustment devices are attached to the surface of the frame on the interior of the building.

However, the burglar retardance in the tilted state of the casement is inadequate in security windows of this type. In this state, the locking elements are not active, because they are not engaged with one another due to the corresponding position of the pushrods, but rather are displaced in relation to one another by displacement of the pushrod and are disengaged. In burglar-retardant security windows as well, in this case, the connection of the casement to the frame in the area of the tilt axis is typically formed solely by standard tilt-turn bands in the area of the vertical rotational axis of a tilt-turn window and/or a bearing socket on the diametrically opposite side of the casement, a bearing element actuated using the pushrod engaging in the bearing socket in the tilt position. Fitting parts of this type, as they are also used in standard windows which do not have to meet security requirements, do not withstand stronger and more sustained attacks on the security window in the tilted position.

However, it is increasingly viewed as inadequate in this context if a security window only has sufficient security properties in the closed position. Rather, it is also desirable to be able to leave a security window fixed in the tilted position for reasons of adequate ventilation, without the burglar-retardant effect being entirely and/or largely lost in this way. In addition, the problem arises that it is undesirable and/or frequently very difficult to always check whether all windows are located in the closed position of the casement, which is the only satisfactory position from security aspects.

It would therefore be desirable and advantageous to provide an improved burglar-retardant security window or door to obviate prior art shortcomings and to provide a security window or a security door in a burglar-retardant embodiment, which provides security both in relation to horizontal movement of the lower end of the casement perpendicular to the tilt axis and also vertical movement of the casement perpendicular to the tilt axis, even in the tilted position of the casement. The fixing of the casement in relation to the frame is to have as little play as possible and/or is preferably to be entirely free of play.

### SUMMARY OF THE INVENTION

According to one aspect of the security window or door according to the present invention the first locking element coupled to the pushrod
either has at least one pin which may be engaged with a matching bearing hole in the second locking element connected fixed to the frame in the tilted position and/or in the closed position of the pushrod,
or has at least one bearing hole, with which a pin of the second locking element, which is connected fixed to the frame, may be engaged in the tilted position and/or the closed position of the pushrod.

In a tilt-turn window, in the tilted position of the casement, a formfitting engagement between a locking element fixed on the frame and a locking element displaceable using the pushrod, which is a type of additional hinge and/or pivot joint, the rotational axis of this auxiliary joint being coincident with the tilt axis. The production of this additional form fit between casement and frame, which must be deactivated in the rotating position of the pushrod to allow the rotational movement of the casement, is performed very comfortably by actuating the pushrod, which is in turn typically actuated by a one-hand rotating handle. The user therefore does not notice the production of this additional form fit, but rather it occurs automatically upon the changeover between the rotating position and the tilted position. The advantage, in addition to the very high comfortability, is also that the production of this security-relevant additional form fit cannot be forgotten, which would affect the security properties very disadvantageously.

One advantage of the formfitting engagement according to the present invention in the form of an additional band and/or pivot joint is that it prevents a relative movement between casement and frame with very little play and/or almost without play in all directions perpendicular to the tilt axis. An auxiliary pivot joint of this type thus differs very advantageously from other locking elements engaging in one another in a formfitting way known from the prior art, for example, in the form of elements in the form of male and female molds or those having a groove-mushroom head engagement.

One possibility for implementing the auxiliary pivot joint between frame and casement is that the locking element coupled to the pushrod has at least one pin which may be engaged with a matching bearing hole in a locking element connected fixed to the frame in the tilted position and/or in the closed position of the pushrod. Alternatively to this, it is also possible that the locking element coupled to the pushrod has at least one bearing, with which a pin of a locking element connected fixed to the frame may be engaged in the tilted position and/or the closed position of the pushrod. In principle, it is even possible that the locking element coupled to the pushrod has a pin on one side which may be engaged with a matching bearing hole in a first locking element, which is connected fixed to the frame, in the tilted position or in the closed position of the pushrod, and the locking element coupled to the pushrod also has a bearing hole on the diametrically opposite side, with which a pin of a second locking element, which is connected fixed to the frame, may be engaged in the closed position or in the tilted position of the pushrod.

According to an especially preferred embodiment of the window according to the present invention or the door according to the present invention, both locking elements are covered by an edge bracket of the casement so they are invisible from a room of the building having the opening to be closed, so that the window or the door according to the present invention may also meet higher architectonic or aesthetic demands. This is made possible in particular because the pushrod runs in a mortise area of the window and is thus also not visible.

To further implement the present invention, it is suggested that the first locking element coupled to the pushrod engage in a formfitting way with an engagement area in a chamber of the casement profile in such a way that the locking element may solely be displaced into the casement profile from an open front side of a leg of the casement.

In this way, a very stable formfitting connection between the engagement area of the locking element and the coupling area thereof is provided. This is of special significance because the pushrod is typically only inadequately connected fixed to the bearing groove assigned thereto, so that even with a very loadable connection between the locking element and the pushrod, the latter could be torn out of the casement profile if the engagement area according to the present invention did not engage in a formfitting way in a chamber of the casement profile, so that in this case the strength of the walls of the casement profile is used.

Moreover, it is especially advantageous if a third locking element connected fixed to the frame is provided, with which the first locking element coupled to the pushrod engages using a side which is diametrically opposite the second locking element connected fixed to the frame in the closed position of the pushrod. In this way, an additional formfitting connection is achieved not only in the tilted position, but rather also in the closed position, the types of formfitting connections in the closed position and also the tilted position preferably being implemented identically. The locking element on the pushrod side is only free and not engaged with either of the two locking elements situated fixed on the frame in the rotating position of the pushrod, which is typically situated between the closed and tilted positions in typical handle actuators.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a section through a frame-casement combination having a locking element mounted fixed on the frame side,

FIG. 2 is similar to FIG. 1, but having a locking element on the casement side coupled to the pushrod,

FIG. 3 is a view of a corner area of a security window having two locking elements mounted fixed on the frame side and one locking element on the casement side coupled to the pushrod,

FIG. 4 is similar to FIG. 1, but having an inner casement profile enlarged in depth,

FIG. 5 is similar to FIG. 2, but having a casement profile enlarged in depth,

FIG. 6 is similar to FIG. 1, but having an inner casement profile reduced in depth and a screwed-on auxiliary profile,

FIG. 7 is similar to FIG. 2, but having an inner casement profile reduced in depth having a screwed-on auxiliary valve.

### DETAILED DESCRIPTION OF PREFERRED EMBODIMENTS

Throughout all the Figures, same or corresponding elements are generally indicated by same reference numerals.

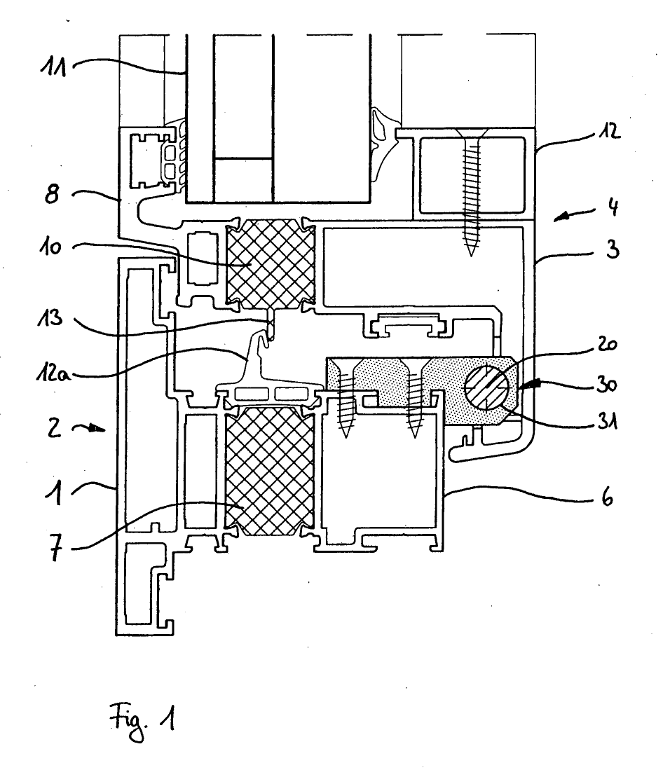

Turning now to the drawing, and in particular with reference to FIGS. 1 through 3, there is shown a security window which comprises a frame 2 anchored fixed in an opening of a building and a casement 4, provided with a filling 11 made of an insulating security glass, which is mounted in the frame 2 so it is tiltable around a horizontal tilt axis 20 and rotatable around a vertical rotational axis (not shown). On the side diametrically opposite the tilt axis, the casement 4 is connected using a security scissor hinge (not visible) to the frame 2, the security scissor hinge preventing further deflection in a tilt final position, in which the casement 4 is pivoted inward by a tilt angle of approximately 10° in relation to the frame 2, the security scissor hinge being under tension in this case.

The frame 2 comprises an external frame profile 1, which is coupled via an insulating web 7 to an inner frame profile 6. In the same way, the casement 4 comprises an external casement profile 8 and an internal casement profile 3 coupled thereto via an insulating web 10. The filling 11 is held in the casement 4 using a glass retention bracket 12. A middle seal 12a situated between the internal frame profile 6 and the external frame profile 1 corresponds to a web 13, which is situated on the insulating web 10 of the casement 4.

A second locking element 30 shown in FIG. 1, which is connected fixed on the frame side to the internal frame profile 6, has a cylindrical pin 31 running perpendicularly to the plane of the drawing of FIG. 1, which is milled on the free front side and projects out of the main body 32 of the second locking element 30.

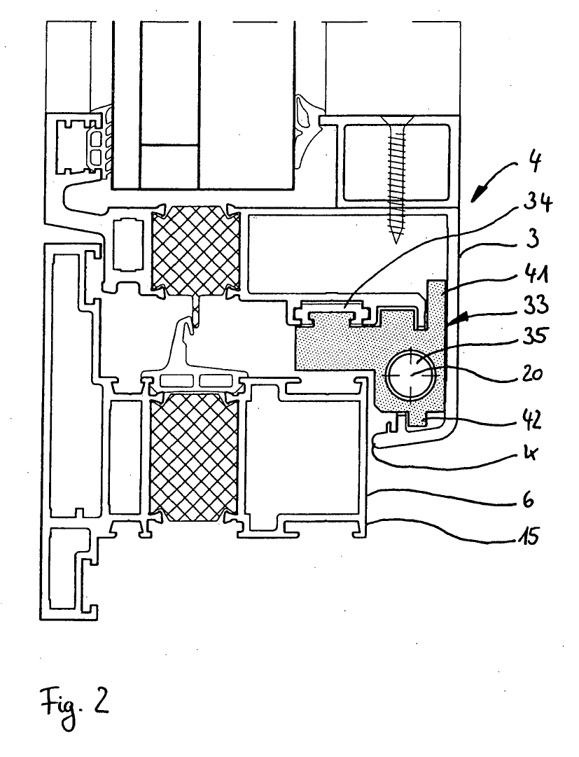

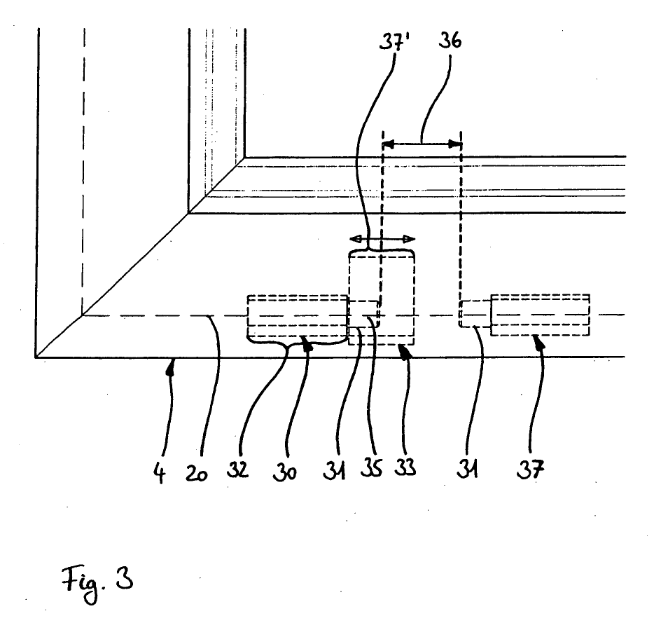

In contrast, FIG. 2 shows a first locking element 33 situated on the casement side, which is coupled to a pushrod 34 and is displaceable corresponding to the movement of the pushrod 34 in relation to the casement 4 within its internal casement profile 3 in a direction parallel to the tilt axis 20. The first locking element 33 has a bearing hole 35 milled on the front side, whose diameter is tailored to the diameter of the pin 31 of the second locking element 30 on the frame 2. The engagement conditions are shown in FIG. 3. In this position of the locking elements 30 and 33 to one another, the casement 4 of the window is transferable from the closed position shown in FIGS. 1 and 2 into the tilted position (not shown in the drawing), a pivot movement occurring around the tilt axis 20. The lower inner edge “k” of the internal casement profile 3 precisely abuts the visible side 15 of the internal frame profile 6.

Both in FIG. 1 and also in FIG. 2, both locking elements 30 and 33 would be visible depending on the selected sectional plane. However, for the sake of clarity, only the second locking element 30 shown in FIG. 1 and only the first locking element 33 is shown in FIG. 2, while in contrast both are shown in FIG. 3.

Furthermore, it is obvious from FIG. 3 that a third locking element 37 mounted fixed on the frame side is provided at a distance 36 between the pins 31 and is situated in a mirror image to the second locking element 30, i.e., the two pins 31 point toward one another. The width 37′ of the first locking element 33, which is coupled to the pushrod and displaceable in the horizontal direction parallel to the tilt axis 20, is slightly less than the distance 36 between the locking elements 30 and 37, so that in the rotating position of the pushrod 34, in which the first locking element 33 is located precisely between the two locking elements 30 and 37, there is no engagement, so that the casement 4 may be rotated around a vertical rotational axis together with the first locking element 33.

The third locking element 37 on the frame side is used to increase the security in the closed position of the pushrod 34, with which the first locking element 33, which is provided with a through bearing hole, may also be engaged in a formfitting way like an auxiliary pivot joint. This position is not shown for reasons of clarity in FIG. 3, however.

To increase the strength of the casement 4, it may comprise solid material or be provided with a reinforcement inlay in the area of the engagement of the locking elements 30, 37 fixed on the frame.

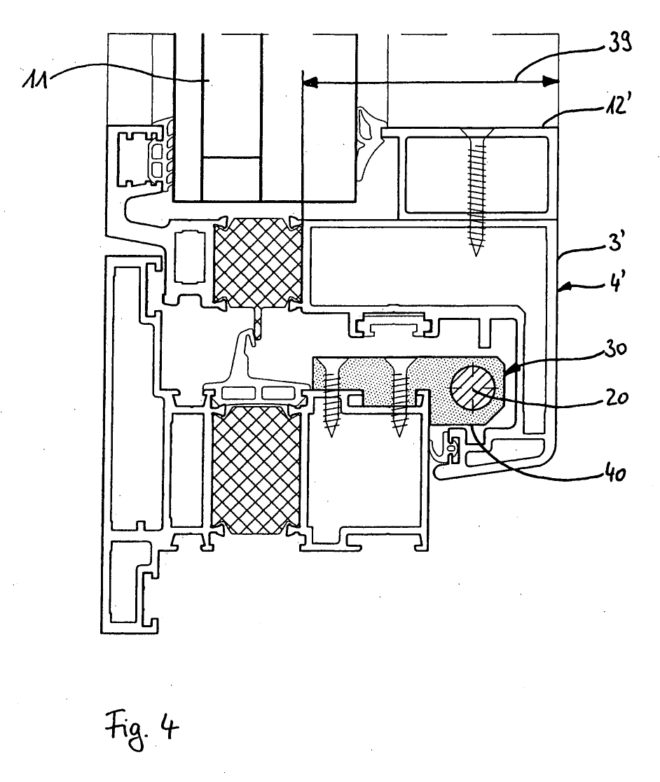

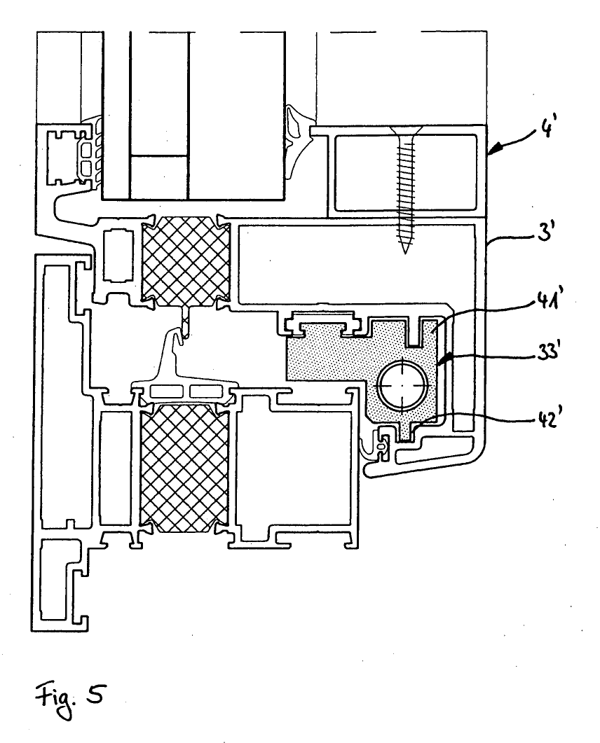

The window illustrated in FIGS. 4 and 5 differs from that shown in FIGS. 1 through 3 solely in the internal casement profile 3′, which is enlarged in its depth 39, and the glass retention bracket 12′, which is adapted in depth thereto. This depth 39 makes superfluous a cutout in the form of a milled out area, as is required in the embodiment in FIG. 1 for the second locking element 30 on the frame side. The tilt axis 20 and the entire second locking element 30 lie outside the internal casement profile 3. Nonetheless, the internal casement profile 3 in FIG. 4 also causes engagement behind the bottom side 40 of the second locking element 30, so that the casement 4′ is additionally secured against a vertical movement and/or movement parallel to the filling 11 in the tilted state of the casement 3.

As shown in FIG. 5, the first locking element 33′ situated on the casement side, and also the first locking element 33 in FIG. 2, is coupled in a formfitting way using two engagement areas 41′ or 42′ to the internal casement profile 3′ to increase the resistance against being torn out. These are equivalent to engagement areas 41 and 42 in the first locking element 33 from FIG. 2.

The engagement conditions in the tilted position and in the closed position as well as the engagement not provided in the rotating position of the casement correspond to the illustrations in FIG. 3.

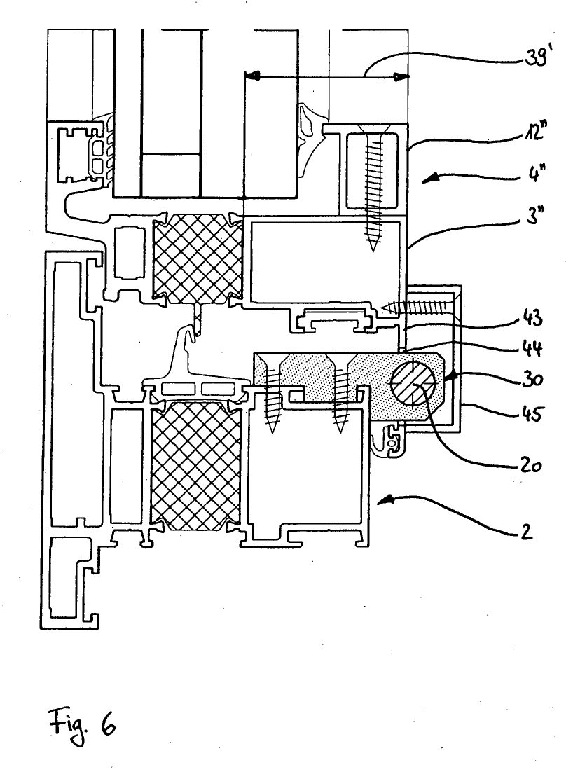

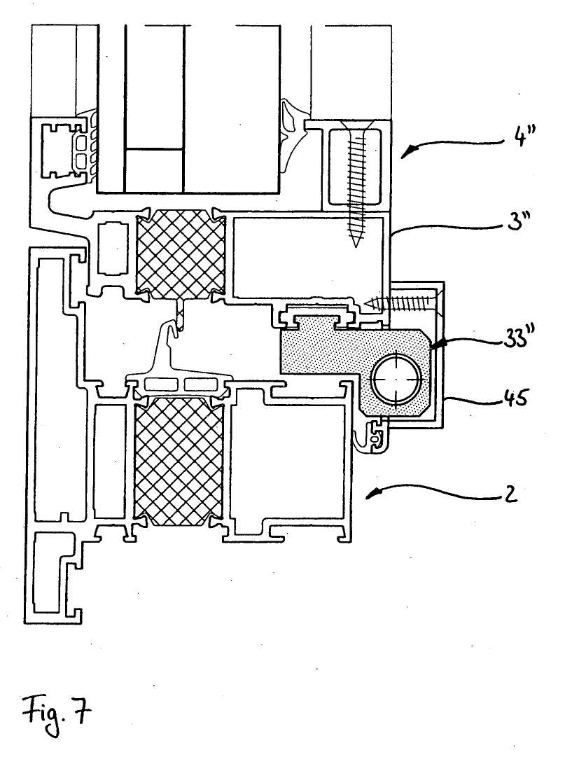

In contrast to the embodiment shown in FIGS. 4 and 5, the embodiment shown in FIGS. 6 and 7 has an internal casement profile 3″, having a reduced depth 39′ and a glass retention bracket 12′ which is also adapted accordingly. Because the second locking element 30 on the frame side nonetheless has a depth corresponding to the other embodiments, a milled-out area 44 must be provided for the second locking element 30 in a wall 43 of the internal casement profile 3″ and, in addition, for visual reasons, an auxiliary profile 45 which is U-shaped in cross-section is screwed onto the interior of the internal casement profile 3″, to cover both the second locking element 30 and also the recess 44 so they are invisible to an observer in the interior of the room. Both fixing in the vertical direction and also fixing of the casement 4″ in the horizontal direction parallel to the tilt axis 20 may be achieved easily by the recess.

While the invention has been illustrated and described as embodied in a security window or door, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A security window or door, comprising:
a frame constructed for anchoring in an opening of a building;
a casement received in the frame, said casement being tiltable about a horizontal tilt axis and rotatable about a vertical rotational axis, said casement including a pushrod disposed in a mortise area between the casement and the frame and movable between a tilt position in which the casement is tiltable, and a rotation position in which the casement is rotatable;
a first locking element firmly coupled to the pushrod; and
a second locking element securely fixed in the frame and formfittingly engaging the first locking element in the tilt position of the pushrod so that the first and second locking elements are pivotable in relation to one another about the tilt axis,
wherein the first locking element is disengageable from the second locking element in the rotation position of the pushrod to allow a rotation of the casement about the rotational axis.

2. The security window or door of claim 1, wherein at least one security scissor hinge is connecting the frame and the casement and limiting a tilting movement of the casement, and wherein scissor hinge is arranged on a side of the casement in opposition to the tilt axis.

3. The security window or door of claim 1, wherein the casement includes a filling.

4. The security window or door of claim 1, wherein the first locking element has at least one pin for engagement in a corresponding bearing hole in the second locking element securely connected to the frame in the tilted position and/or in a closed position of the pushrod.

5. The security Window or door of claim 1, wherein the first locking element is provided with at least one bearing hole and the second locking element has pin for engagement with the bearing hole in the first locking element when the pushrod is in a tilted or closed position.

6. The security window or door according to claim 1, wherein both locking elements are covered by an edge strip of the casement so they are invisible from view.

7. The security window or door according to claim 1, wherein the first locking element is provided with engagement projections that are corresponding in formfitting manner to recesses within the casement such that the locking element is insertable into the casement profile only from an open front side of a leg of the casement.

8. The security window or door according to claim 1, further comprising a third locking element securely connected to the frame and in engagement with the first locking element on a side which is diametrically opposite the second locking element when the pushrod is in closed position.
